(19) United States
(12) Patent Application Publication
(10) Pub. No.: US 2025/0097791 A1
(43) Pub. Date: Mar. 20, 2025

(54) SWITCHING CONFIGURATIONS FOR UPLINK TRANSMISSION SWITCHING

(71) Applicant: QUALCOMM Incorporated, San Diego, CA (US)

(72) Inventors: Yiqing CAO, Beijing (CN); Peter GAAL, San Diego, CA (US); Alberto RICO ALVARINO, San Diego, CA (US); Yi HUANG, San Diego, CA (US); Gokul SRIDHARAN, Sunnyvale, CA (US); Kazuki TAKEDA, Minato-ku (JP); Timo Ville VINTOLA, San Diego, CA (US); Bin HAN, Beijing (CN); Juan MONTOJO, San Diego, CA (US); Wanshi CHEN, San Diego, CA (US)

(21) Appl. No.: 18/294,127

(22) PCT Filed: Oct. 20, 2021
(86) PCT No.: PCT/CN2021/124881

§ 371 Date: Jan. 31, 2024

(51) Int. Cl. H04W 36/00; H04W 36/06

(52) U.S. Cl. CPC H04W 36/0069; H04W 36/06

(57) ABSTRACT

This disclosure provides systems, methods and apparatuses for switching configurations for uplink transmission switching. A user equipment (UE) may receive, from a network entity such as a base station, a switching configuration for an uplink transmission switching for three or more carriers. The switching configuration may be associated with switching one or more uplink transmission chains of the UE from or to one or more carriers of the three or more carriers within a time period. The switching configuration may be associated with a UE capability. The switching configuration may permit switching from or to one carrier within the time period associated with the UE capability. The switching configuration may permit switching from or to two carriers within the time period associated with the UE capability. The switching configuration may depend on the UE capability, thereby not causing the uplink transmission switching to degrade a performance of the UE.

### TECHNICAL FIELD

Aspects of the present disclosure relate generally to wireless communication and to techniques for switching configurations for uplink transmission switching.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by an apparatus of a user equipment (UE). The method may include receiving, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The method may include switching the one or more uplink transmission chains of the UE associated with the switching configuration for the uplink transmission switching.

Another innovative aspect of the subject matter described in this disclosure can be implemented in an apparatus of a UE for wireless communication. The apparatus may include a first interface configured to receive, from a network entity, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The apparatus may include a processing system configured to switch the one or more uplink transmission chains of the UE associated with the switching configuration for the uplink transmission switching.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to receive, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The one or more instructions, when executed by one or more processors of a UE, may cause the one or more processors to switch the one or more uplink transmission chains of the UE associated with the switching configuration for the uplink transmission switching.

Another innovative aspect of the subject matter described in this disclosure can be implemented in an apparatus for wireless communication. The apparatus may include means for receiving, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The apparatus may include means for switching the one or more uplink transmission chains of the UE associated with the switching configuration for the uplink transmission switching.

Another innovative aspect of the subject matter described in this disclosure can be implemented in a method of wireless communication performed by an apparatus of a network entity. The method may include transmitting, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The method may include receiving, from the UE, an uplink transmission associated with the switching configuration for the uplink transmission switching.

Another innovative aspect of the subject matter described in this disclosure can be implemented in an apparatus of a network entity for wireless communication. The apparatus may include a first interface configured to output, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The apparatus may include the first interface or a second interface configured to obtain, from the UE, an uplink transmission associated with the switching configuration for the uplink transmission switching.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a network entity, may cause the one or more processors to transmit, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The one or more instructions, when executed by one or more processors of a network entity, may cause the one or more processors to receive, from the UE, an uplink transmission associated with the switching configuration for the uplink transmission switching.

Another innovative aspect of the subject matter described in this disclosure can be implemented in an apparatus for wireless communication. The apparatus may include means for transmitting, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period. The apparatus may include means for receiving, from the UE, an uplink transmission associated with the switching configuration for the uplink transmission switching.

Aspects generally include a method, apparatus, system, computer program product, non-transitory computer-readable medium, user equipment, base station, wireless communication device, or processing system as substantially described herein with reference to and as illustrated by the accompanying drawings.

Details of one or more implementations of the subject matter described in this disclosure are set forth in the accompanying drawings and the description. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a base station in communication with a user equipment (UE) in a wireless network.

FIG. 3 is a diagram illustrating an example of uplink transmission switching for two or more carriers.

FIGS. 4-6 are diagrams illustrating examples associated with switching configurations for uplink transmission switching.

FIG. 7 is a diagram illustrating an example process performed, for example, by a UE.

FIG. 8 is a diagram illustrating an example process performed, for example, by a network entity.

FIGS. 9 and 10 are diagrams of example apparatuses for wireless communication.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G technology, 4G technology, 5G technology, or further implementations thereof.

A UE may have two uplink transmission chains, where each uplink transmission chain may support more than one carrier. For example, the two uplink transmission chains may support both a first carrier and a second carrier. An uplink transmission chain may have radio frequency (RF) components to amplify and filter uplink signals for transmission from the UE to a network entity. With uplink transmission switching, the UE may switch either one uplink transmission chain (1Tx) or the two uplink transmission chains (2Tx) to a different carrier. For example, during the uplink transmission switching, the UE may switch the two uplink transmission chains from the first carrier to the second carrier. The UE may use uplink transmission switching to perform uplink transmissions on different carriers supported by the two uplink transmission chains of the UE.

During the uplink transmission switching, the UE may attempt to simultaneously switch one or two uplink transmission chains from two or more carriers, or the UE may attempt to simultaneously switch one or more uplink transmission chains to two or more carriers. For example, the UE may attempt to simultaneously switch one carrier associated with a first carrier and another carrier associated with a third carrier to a second carrier. As another example, the UE may attempt to simultaneously switch one carrier associated with the first carrier and another carrier associated with the first carrier to the second carrier and the third carrier, respectively. In other words, the UE may attempt to switch from, or to, more than one carrier at a same time. However, simultaneous switching from two or more carriers or to two or more carriers may not be possible based on limitations associated with RF components of the UE. In these cases, during the uplink transmission switching, UEs that are not capable of simultaneous switching from two or more carriers or to two or more carriers may suffer from a performance degradation.

In various aspects of techniques and apparatuses described herein, a UE may receive, from a network entity (such as a base station), a switching configuration for an uplink transmission switching for three or more carriers. The switching configuration may be associated with switching one or more uplink transmission chains of the UE from one or more carriers of the three or more carriers within a time period. The switching configuration may be associated with switching the one or more uplink transmission chains of the UE to the one or more carriers of the three or more carriers within the time period. In some aspects, the switching configuration may permit switching from one carrier within the time period, or the switching configuration may permit switching to one carrier within the time period. In some aspects, the switching configuration may permit switching from two carriers within the time period, or the switching configuration may permit switching to two carriers within the time period, associated with capability signaling transmitted by the UE. The UE may switch the one or more uplink transmission chains of the UE associated with the switching configuration for the uplink transmission switching.

In some aspects, the UE may perform the uplink transmission switching in accordance with the capability signaling. For example, when the capability signaling indicates that the UE is capable of switching from the two carriers within the time period, or switching to the two carriers within the time period, the switching configuration may permit switching from the two carriers within the time period or switching to the two carriers within the time period. On the other hand, when the capability signaling indicates that the UE is not capable of switching from the two carriers within the time period, or switching to the two carriers within the time period, the switching configuration may permit switching from the one carrier within the time period or switching to the one carrier within the time period. For example, the UE may include various RF components (for example, amplifiers and filters) that do not allow the UE to switch from more than one carrier or switch to more than one carrier within the time period. In this case, attempting to switch from more than one carrier or switch to more than one carrier, without such capability at the UE, may cause the UE to suffer from a performance degradation. As a result, the switching configuration transmitted by the network entity may be associated with the capability signaling transmitted by the UE.

In some aspects, when the three or more carriers are supported, allowing switching for two or more carriers/bands at a same time (or within a relatively short time period) may cause an ambiguity when switching from a source carrier to a target carrier and other issues, such as RF synchronization and increased interruption. In some cases, allowing one switch at a single time may avoid the ambiguity.

Particular implementations of the subject matter described in this disclosure can be implemented to realize one or more of the following potential advantages. The switching configuration associated with the capability signaling may reduce latency, increase throughput, and reduce a power consumption by reducing an implementation complexity at the UE. Additionally, the switching configuration associated with the capability signaling may cause the UE to avoid ambiguities when switching from the source carrier to the target carrier, and the switching configuration may not cause issues related to the RF synchronization and the increased interruptions, thereby resulting in the reduced latency, the increased throughput, and the reduced power consumption.

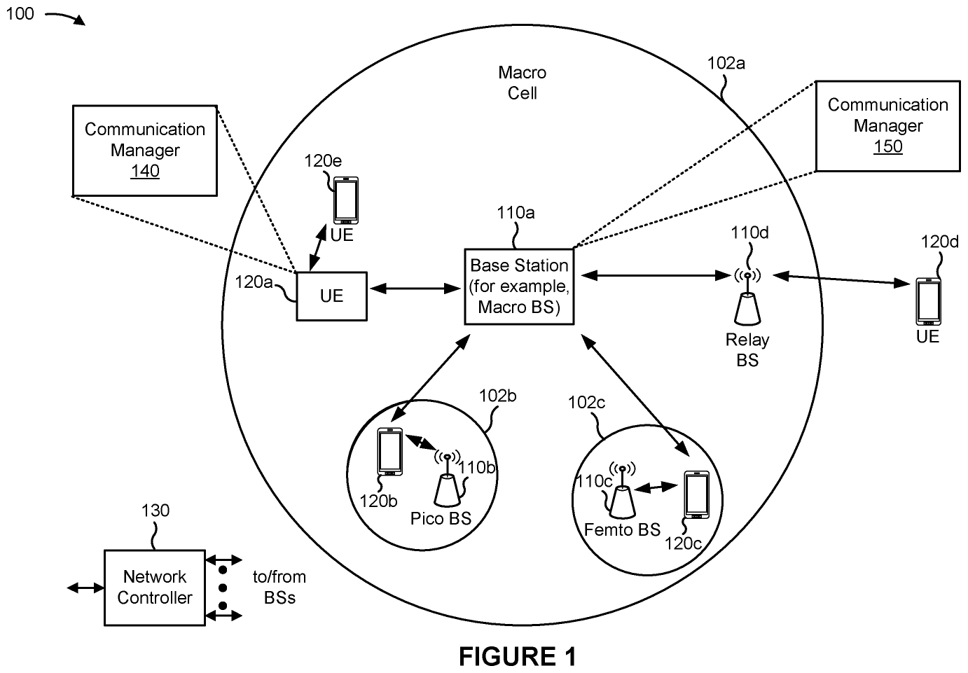

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network entities, such as one or more base stations (BSs) 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an example of a network entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells.

In some examples, a cell may not necessarily be stationary, and the geographic area of the cell may move according to the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHZ-114.25 GHZ), and FR5 (114.25 GHZ-300 GHz). Each of these higher frequency bands falls within the EHF band.

With these examples in mind, unless specifically stated otherwise, it should be understood that the term “sub-6 GHZ,” if used herein, may broadly represent frequencies that may be less than 6 GHZ, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (for example, UE 120) may include a communication manager 140. As described in more detail elsewhere herein, the communication manager 140 may receive, from a network entity, a switching configuration for an uplink transmission switching for three or more carriers, where the switching configuration is associated with: switch one or more uplink transmission chains of the UE from one or more carriers of the three or more carriers within a time period, or switch the one or more uplink transmission chains of the UE to the one or more carriers of the three or more carriers within the time period; and switch the one or more uplink transmission chains of the UE associated with the switching configuration for the uplink transmission switching. Additionally, or alternatively, the communication manager 140 may perform one or more other operations described herein.

In some aspects, a network entity (for example, base station 110) may include a communication manager 150. As described in more detail elsewhere herein, the communication manager 150 may transmit, to a UE, a switching configuration for an uplink transmission switching at the UE for three or more carriers, where the switching configuration is associated with: switch one or more uplink transmission chains of the UE from one or more carriers of the three or more carriers within a time period, or switch the one or more uplink transmission chains of the UE to the one or more carriers of the three or more carriers within the time period; and receive, from the UE, an uplink transmission associated with the switching configuration for the uplink transmission switching. Additionally, or alternatively, the communication manager 150 may perform one or more other operations described herein.

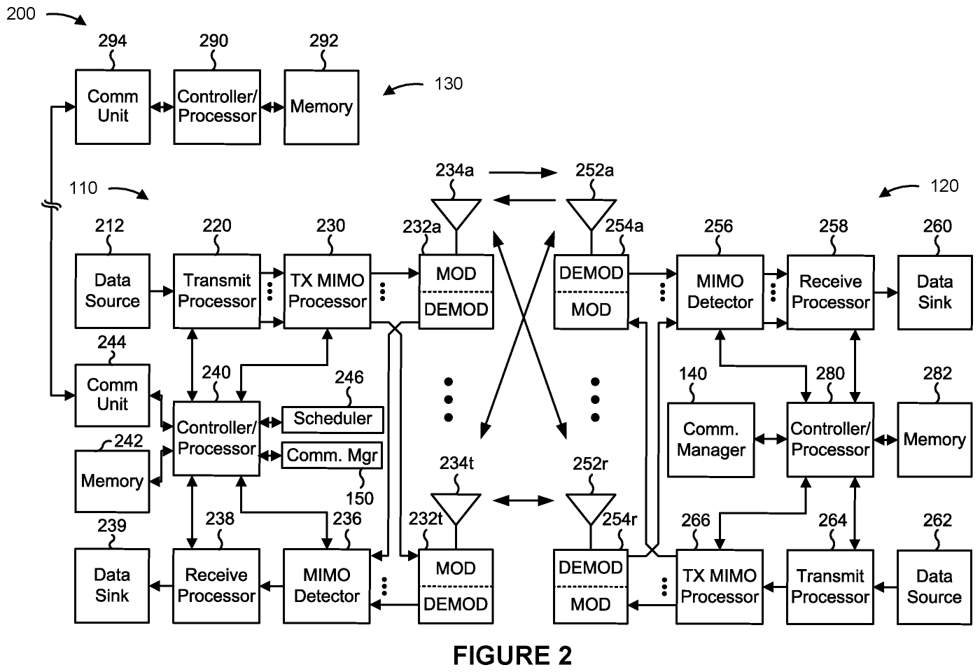

FIG. 2 is a diagram illustrating an example 200 of a base station 110 in communication with a UE 120 in a wireless network 100. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The base station 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the base station 110). For example, a processing system of the base station 110 may be a system that includes the various other components or subcomponents of the base station 110.

The processing system of the base station 110 may interface with one or more other components of the base station 110, may process information received from one or more other components (such as inputs or signals), or may output information to one or more other components. For example, a chip or modem of the base station 110 may include a processing system, a first interface to receive or obtain information, and a second interface to output, transmit, or provide information. In some examples, the first interface may be an interface between the processing system of the chip or modem and a receiver, such that the base station 110 may receive information or signal inputs, and the information may be passed to the processing system. In some examples, the second interface may be an interface between the processing system of the chip or modem and a transmitter, such that the base station 110 may transmit information output from the chip or modem. A person having ordinary skill in the art will readily recognize that the second interface also may obtain or receive information or signal inputs, and the first interface also may output, transmit, or provide information.

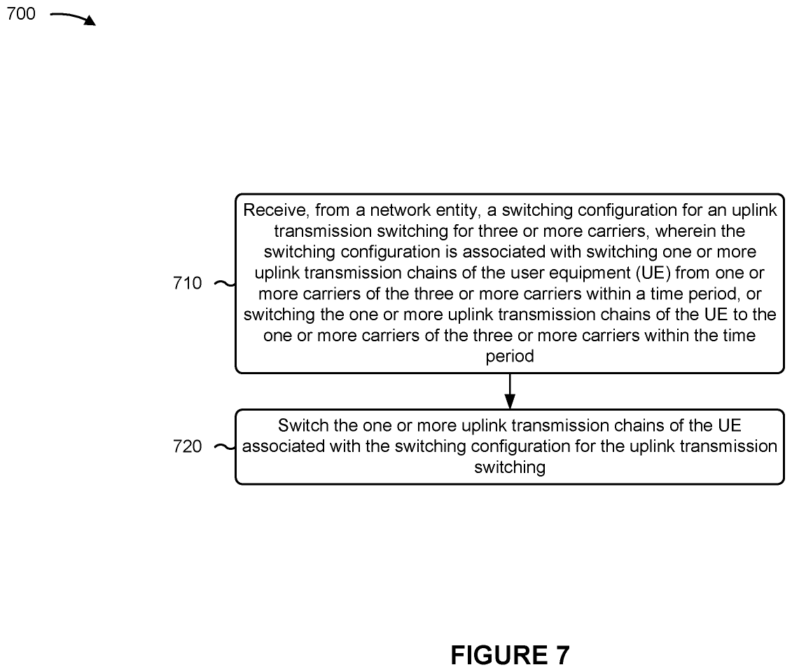

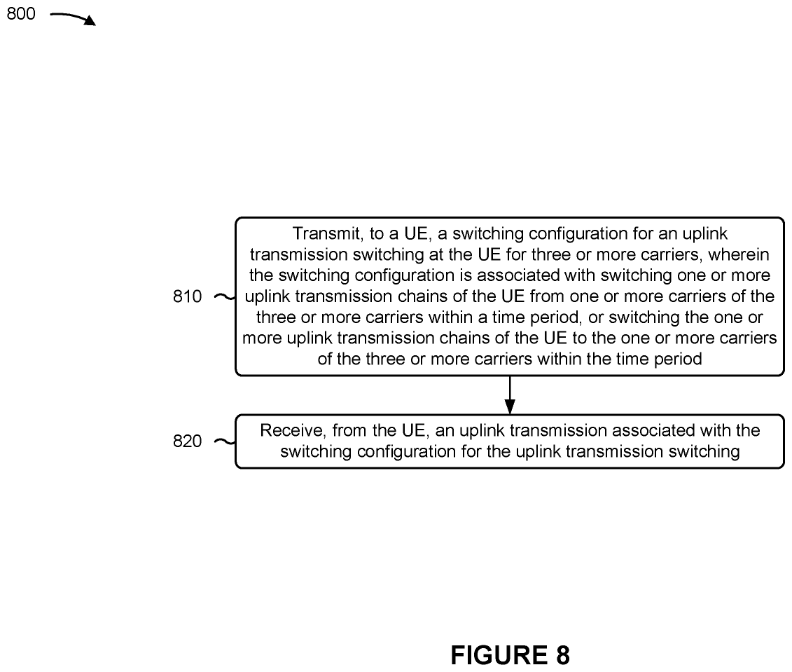

The controller/processor 240 of the base station 110, the controller/processor 280 of the UE 120, or any other component(s) of FIG. 2 may perform one or more techniques associated with switching configurations for uplink transmission switching, as described in more detail elsewhere herein. In some aspects, the network entity described herein is the base station 110, is included in the base station 110, or includes one or more components of the base station 110 shown in FIG. 2 For example, the controller/processor 240 of the base station 110, the controller/processor 280 of the UE 120, or any other component(s) (or combinations of components) of FIG. 2 may perform or direct operations of, for example, process 700 of FIG. 7, process 800 of FIG. 8, or other processes as described herein. The memory 242 and the memory 282 may store data and program codes for the base station 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 700 of FIG. 7, process 800 of FIG. 8, or other processes as described herein. In some examples, executing instructions may include running the instructions, converting the instructions, compiling the instructions, or interpreting the instructions.

In some aspects, a UE (for example, UE 110) includes means for receiving, from a network entity, a switching configuration for an uplink transmission switching for three or more carriers, where the switching configuration is associated with: means for switching one or more uplink transmission chains of the UE from one or more carriers of the three or more carriers within a time period, or means for switching the one or more uplink transmission chains of the UE to the one or more carriers of the three or more carriers within the time period; or means for switching the one or more uplink transmission chains of the UE associated with the switching configuration for the uplink transmission switching. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (for example, base station 110) includes means for transmitting, to a UE, a switching configuration for an uplink transmission switching at the UE for three or more carriers, where the switching configuration is associated with: means for switching one or more uplink transmission chains of the UE from one or more carriers of the three or more carriers within a time period, or means for switching the one or more uplink transmission chains of the UE to the one or more carriers of the three or more carriers within the time period; or means for receiving, from the UE, an uplink transmission associated with the switching configuration for the uplink transmission switching. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

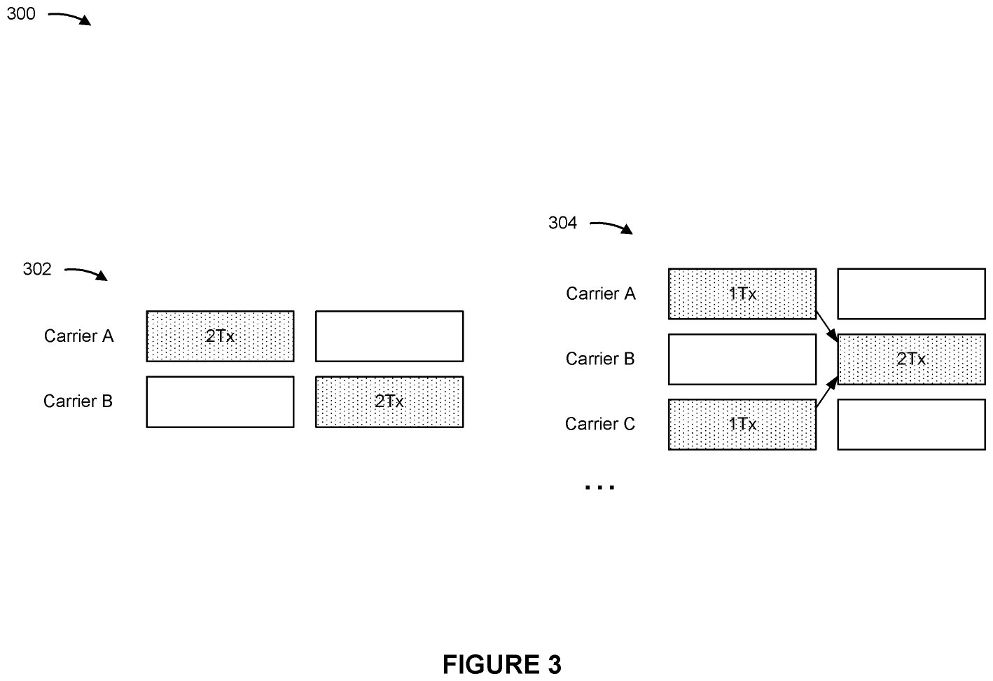

FIG. 3 is a diagram illustrating an example 300 of uplink transmission switching for two or more carriers.

As shown by reference number 302, during uplink transmission switching, a UE (for example, the UE 120 depicted and described in FIGS. 1 and 2) may switch two uplink transmission chains from a first carrier (Carrier A) to a second carrier (Carrier B). Alternatively, during the uplink transmission switching, the UE may switch one uplink transmission chain from the first carrier to the second carrier.

As shown by reference number 304, during uplink transmission switching, the UE may switch one uplink transmission chain from the first carrier to the second carrier, and the UE may attempt to simultaneously switch one uplink transmission chain from a third carrier (Carrier C) to the second carrier. After the uplink transmission switching, the UE may use both uplink transmission chains for the second carrier. In this case, the UE may attempt to switch from more than one carrier at a same time.

In an alternative example, during the uplink transmission switching, the UE may switch one uplink transmission chain from the first carrier to the second carrier, and the UE may attempt to simultaneously switch another uplink transmission chain from the first carrier to the third carrier. After the uplink transmission switching, the UE may use one uplink transmission chain for the second carrier, and the UE may use another uplink transmission chain for the third carrier. In this case, the UE may attempt to switch to more than one carrier at a same time.

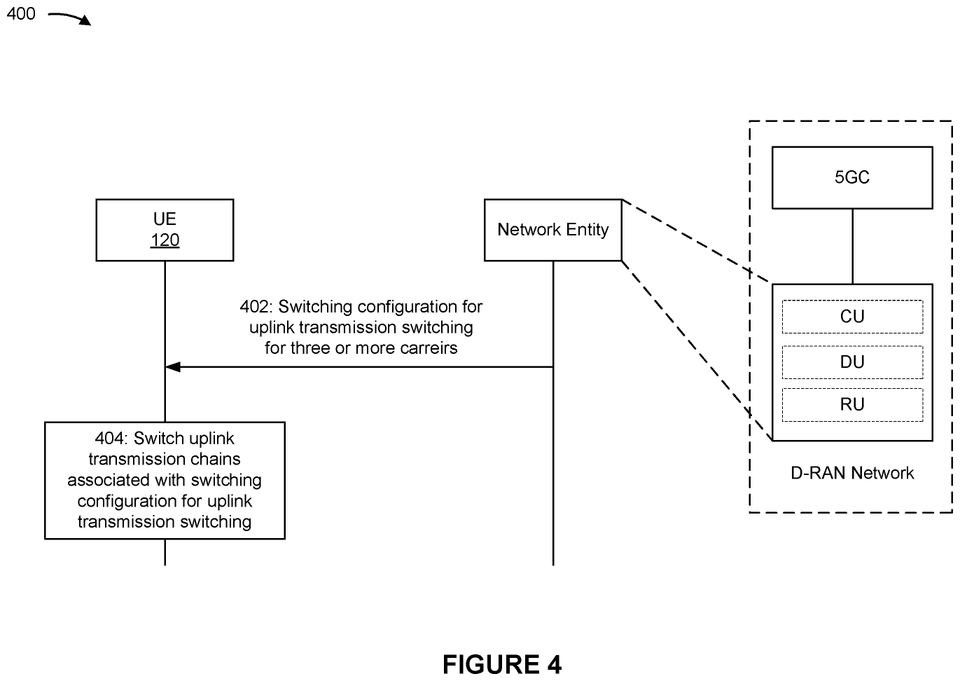

FIG. 4 is a diagram illustrating an example 400 associated with switching configurations for uplink transmission switching. As shown in FIG. 4, example 400 includes communication between a UE (for example, the UE 120 depicted and described in FIGS. 1 and 2) and a network entity (for example, the base station 110 depicted and described in FIGS. 1 and 2). In some aspects, the UE and the network entity may be included in a wireless network, such as wireless network 100.

In some aspects, the network entity may be configured in a distributed radio access network (D-RAN), an open radio access network (O-RAN), or a virtual radio access network (V-RAN), and one or more components of such network entity configurations may provide switching configurations for uplink transmission switching. The network entity may be connected to a 5G core (5GC) network. The network entity may incorporate a centralized unit (CU), one or more distributed units (DUs), and one or more radio units (RUs). The CU may be disaggregated into a CU user plane (CU-UP) and a CU control plane (CU-CP), both of which may connect to the DU over an F1-U interface and an F1-C interface, respectively. The network entity may be deployed as a monolithic unit at a cell site (such as in a traditional monolithic base station architecture), in which case the CU, the DU, and the RU may all be deployed at the cell site. Alternatively, the network entity may be geographically or virtually split between the CU, the DU, and the RU. In this case, the CU, the DU, and the RU may be deployed at different locations, such as the cell site or at an edge site.

As shown by reference number 402, the UE may receive, from the network entity, a switching configuration for an uplink transmission switching for three or more carriers. The switching configuration may be associated with switching one or more uplink transmission chains of the UE from one or more carriers of the three or more carriers within a time period. The switching configuration may be associated with switching the one or more uplink transmission chains of the UE to the one or more carriers of the three or more carriers within the time period. The time period may be one slot or a quantity of consecutive symbols, including in one non-limiting example, 14 consecutive symbols.

In some aspects, the switching configuration may permit switching from one carrier within the time period. In some aspects, the switching configuration may permit switching to one carrier within the time period. The UE may be permitted to switch from the one carrier within the time period, or to the one carrier within the time period, associated with a capability of the UE. For example, the UE may indicate to the network entity, via a capability signaling, that the UE is not capable of switching from or to more than one carrier within the time period, which may be due to RF component limitations at the UE. In this case, the network entity may transmit the switching configuration that permits the UE switching from or to the one carrier within the time period. Further, when switching from one carrier is permitted within the time period, one carrier of the three or more carriers may be associated with one uplink transmission chain prior to the uplink transmission switching and after the uplink transmission switching.

In some aspects, the UE may transmit, to the network entity, the capability signaling indicating that the UE is capable of switching from two carriers within the time period, or that the UE is capable of switching to the two carriers within the time period. In this case, the network entity may transmit, to the UE, the switching configuration that permits the UE switching from two carriers within the time period, or permits switching to two carriers within the time period. In other words, the switching configuration may permit switching from two carriers within the time period associated with the capability signaling, or the switching configuration may permit switching to two carriers within the time period associated with the capability signaling. In some aspects, the UE being able to simultaneously switch from or two more than one carrier may be an optional feature, and may depend on the capability of the UE.

In some aspects, the three or more carriers may include three carriers associated with three bands, respectively. For example, a first carrier may be associated with a first band, a second carrier may be associated with a second band, and a third carrier may be associated with a third band. In some aspects, the three or more carriers may include three non-contiguous carriers associated with less than three bands. For example, two non-contiguous carriers may be associated with a first band, and a third carrier may be associated with a second band.

As shown by reference number 404, the UE may switch the one or more uplink transmission chains of the UE associated with the switching configuration for the uplink transmission switching. The UE may be configured to perform the uplink transmission switching in accordance with a periodicity. In other words, the UE may be configured via radio resource control (RRC) signaling or another suitable signaling to perform the uplink transmission switching at certain times.

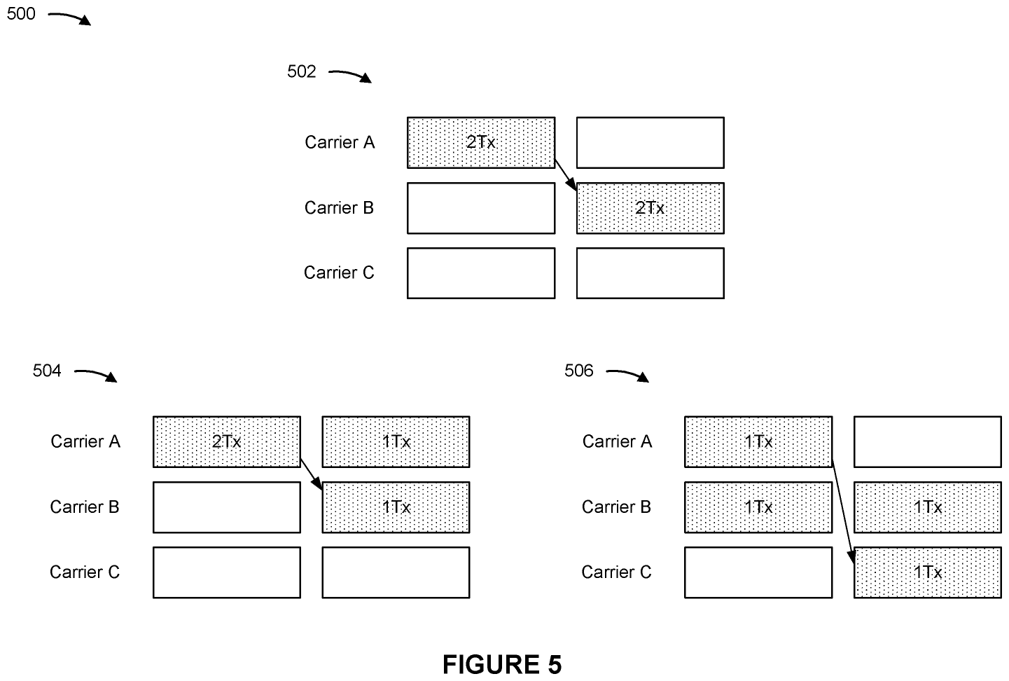

FIG. 5 is a diagram illustrating an example 500 associated with switching configurations for uplink transmission switching.

As shown by reference number 502, a UE (for example, the UE 120 depicted and described in FIGS. 1 and 2) may be configured with three carriers. During uplink transmission switching, the UE may switch two uplink transmission chains from a first carrier (Carrier A) to a second carrier (Carrier B). After the uplink transmission switching, the UE may have the two uplink transmission chains associated with the second carrier. The UE may be permitted to switch both uplink transmission chains between carriers at a same time. In some aspects, the UE may switch the two uplink transmission chains from the first carrier to the second carrier within one slot or X consecutive symbols (for example, 14 consecutive symbols), which may reduce a complexity associated with switching between carriers.

In this example, prior to the uplink transmission switching, two uplink transmission chains may be associated with the first carrier, zero uplink transmission chains may be associated with the second carrier, and zero uplink transmission chains may be associated with a third carrier (Carrier C). After the uplink transmission switching, zero uplink transmission chains may be associated with the first carrier, two uplink transmission chains may be associated with the second carrier, and zero uplink transmission chains may be associated with the third carrier. In other words, in this example, the UE may switch from a single carrier within a certain time period (for example, one slot or X consecutive symbols), and the UE may switch to a single carrier within the certain time period.

As shown by reference number 504, a UE (for example, the UE 120 depicted and described in FIGS. 1 and 2) may be configured with three carriers. During uplink transmission switching, the UE may switch a first uplink transmission chain from a first carrier (Carrier A) to a second carrier (Carrier B). The UE may have a second uplink transmission chain associated with the first carrier that is not involved during the uplink transmission switching. In other words, during the uplink transmission switching, the second uplink transmission chain may remain associated with the first carrier. After the uplink transmission switching, the UE may have one uplink transmission chain associated with the first carrier and another uplink transmission chain associated with the second carrier. The UE may be permitted to switch the first uplink transmission chain from the first carrier to the second carrier, since the first carrier keeps the second uplink transmission chain before and after the uplink transmission switching. In some aspects, the UE may switch the first uplink transmission chain from the first carrier to the second carrier within one slot or X consecutive symbols (for example, 14 consecutive symbols), which may reduce a complexity associated with switching between carriers.

In this example, prior to the uplink transmission switching, two uplink transmission chains may be associated with the first carrier, zero uplink transmission chains may be associated with the second carrier, and zero uplink transmission chains may be associated with a third carrier (Carrier C). After the uplink transmission switching, one uplink transmission chain may be associated with the first carrier, one uplink transmission chain may be associated with the second carrier, and zero uplink transmission chains may be associated with the third carrier. In other words, in this example, the UE may switch from a single carrier within a certain time period (for example, one slot or X consecutive symbols), and the UE may switch to a single carrier within the certain time period.

As shown by reference number 506, a UE (for example, the UE 120 depicted and described in FIGS. 1 and 2) may be configured with three carriers. During uplink transmission switching, the UE may switch a first uplink transmission chain from a first carrier (Carrier A) to a third carrier (Carrier C). The UE may have a second uplink transmission chain associated with a second carrier (Carrier B) that is not involved during the uplink transmission switching. In other words, during the uplink transmission switching, the second uplink transmission chain may remain associated with the second carrier. After the uplink transmission switching, the UE may have one uplink transmission chain associated with the second carrier and another uplink transmission chain associated with the third carrier. The UE may be permitted to switch the first uplink transmission chain from the first carrier to the third carrier, since the second carrier keeps the second uplink transmission chain before and after the uplink transmission switching. In some aspects, the UE may switch the first uplink transmission chain from the first carrier to the third carrier within one slot or X consecutive symbols (for example, 14 consecutive symbols), which may reduce a complexity associated with switching between carriers.

In this example, prior to the uplink transmission switching, one uplink transmission chain may be associated with the first carrier, one uplink transmission chain may be associated with the second carrier, and zero uplink transmission chains may be associated with the third carrier. After the uplink transmission switching, zero uplink transmission chains may be associated with the first carrier, one uplink transmission chain may be associated with the second carrier, and one uplink transmission chain may be associated with the third carrier. In other words, in this example, the UE may switch from a single carrier within a certain time period (for example, one slot or X consecutive symbols), and the UE may switch to a single carrier within the certain time period.

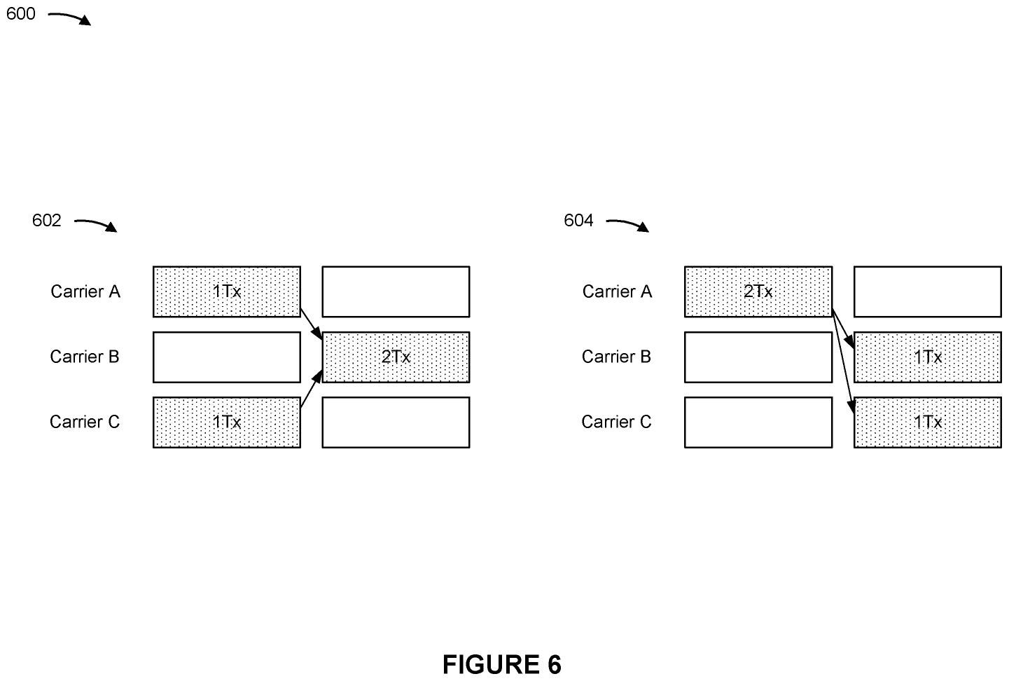

FIG. 6 is a diagram illustrating an example 600 associated with switching configurations for uplink transmission switching.

As shown by reference number 602, a UE (for example, the UE 120 depicted and described in FIGS. 1 and 2) may be configured with three carriers. During uplink transmission switching, the UE may switch a first uplink transmission chain from a first carrier (Carrier A) to a second carrier (Carrier B), and the UE may simultaneously switch a second uplink transmission chain from a third carrier (Carrier C) to the second carrier. After the uplink transmission switching, the UE may have two uplink transmission chains associated with the second carrier. The UE may be able to switch both the first and second uplink transmission chains simultaneously to the second carrier associated with a capability signaling from the UE. In other words, a UE capability may allow the UE to simultaneously switch uplink transmission chains associated with two separate carriers. The UE may include various RF components that allow the UE to simultaneously switch the uplink transmission chains associated with the two separate carriers.

In this example, prior to the uplink transmission switching, one uplink transmission chain may be associated with the first carrier, zero uplink transmission chains may be associated with the second carrier, and one uplink transmission chain may be associated with the third carrier. After the uplink transmission switching, zero uplink transmission chains may be associated with the first carrier, two uplink transmission chains may be associated with the second carrier, and zero uplink transmission chains may be associated with the third carrier. In other words, in this example, the UE may switch from two carriers or to two carriers associated with the UE capability.

In some aspects, the UE may be unable to simultaneously switch the two uplink transmission chains associated with the two separate carriers. For example, the UE capability may prevent the UE from simultaneously switching the two uplink transmission chains associated with the two separate carriers.

As shown by reference number 604, a UE (for example, the UE 120 depicted and described in FIGS. 1 and 2) may be configured with three carriers. During uplink transmission switching, the UE may switch a first uplink transmission chain from a first carrier (Carrier A) to a second carrier (Carrier B), and the UE may simultaneously switch a second uplink transmission chain from the first carrier to a third carrier (Carrier C). After the uplink transmission switching, the UE may have one uplink transmission chain associated with the second carrier and another uplink transmission chain associated with the third carrier. The UE may be able to switch both the first and second uplink transmission chains simultaneously to the second carrier and the third carrier, respectively, associated with a capability signaling from the UE. In other words, a UE capability may allow the UE to simultaneously switch two uplink transmission chains associated with the same carrier to multiple other carriers. The UE may include various RF components that allow the UE to simultaneously switch the two uplink transmission chains associated with the same carrier to the multiple other carriers.

In this example, prior to the uplink transmission switching, two uplink transmission chains may be associated with the first carrier, zero uplink transmission chains may be associated with the second carrier, and zero uplink transmission chains may be associated with the third carrier. After the uplink transmission switching, zero uplink transmission chains may be associated with the first carrier, one uplink transmission chain may be associated with the second carrier, and one uplink transmission chain may be associated with the third carrier. In other words, in this example, the UE may switch from two carriers or to two carriers associated with the UE capability.

In some aspects, the UE may be unable to switch both the first and second uplink transmission chains simultaneously to the second carrier and the third carrier, respectively. For example, the UE capability may prevent the UE from switching both the first and second uplink transmission chains simultaneously to the second carrier and the third carrier, respectively.

FIG. 7 is a diagram illustrating an example process 700 performed, for example, by a UE. The process 700 is an example where the UE (for example, UE 120) performs operations associated with switching configurations for uplink transmission switching.

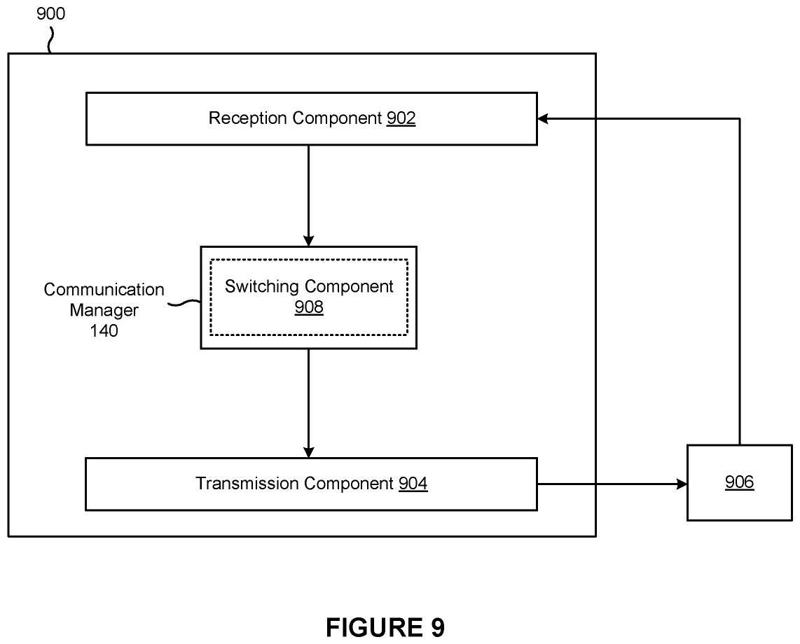

As shown in FIG. 7, in some aspects, the process 700 may include receiving, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period (block 710). For example, the UE (such as by using communication manager 140 or reception component 902, depicted in FIG. 9) may receive, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period.

As further shown in FIG. 7, in some aspects, the process 700 may include switching the one or more uplink transmission chains of the UE associated with the switching configuration for the uplink transmission switching (block 720). For example, the UE (such as by using communication manager 140 or switching component 908, depicted in FIG. 9) may switch the one or more uplink transmission chains of the UE associated with the switching configuration for the uplink transmission switching.

The process 700 may include additional aspects, such as any single aspect or any combination of aspects described in connection with the process 700 or in connection with one or more other processes described elsewhere herein.

In a first additional aspect, the switching configuration permits switching from one carrier within the time period.

In a second additional aspect, alone or in combination with the first aspect, the switching configuration permits switching to one carrier within the time period.

In a third additional aspect, alone or in combination with one or more of the first and second aspects, the time period is one slot or a quantity of consecutive symbols.

In a fourth additional aspect, alone or in combination with one or more of the first through third aspects, the three or more carriers include three carriers associated with three bands, respectively, or the three or more carriers include three non-contiguous carriers associated with less than three bands.

In a fifth additional aspect, alone or in combination with one or more of the first through fourth aspects, the process 700 includes transmitting, to the network entity, capability signaling indicating that the UE is capable of switching from two carriers within the time period, or that the UE is capable of switching to the two carriers within the time period.

In a sixth additional aspect, alone or in combination with one or more of the first through fifth aspects, the switching configuration permits switching from two carriers within the time period associated with the capability signaling.

In a seventh additional aspect, alone or in combination with one or more of the first through sixth aspects, the switching configuration permits switching to two carriers within the time period associated with the capability signaling.

In an eighth additional aspect, alone or in combination with one or more of the first through seventh aspects, one carrier of the three or more carriers is associated with one uplink transmission chain prior to the uplink transmission switching and after the uplink transmission switching.

Although FIG. 7 shows example blocks of the process 700, in some aspects, the process 700 may include additional blocks, fewer blocks, different blocks, or differently arranged blocks than those depicted in FIG. 7. Additionally, or alternatively, two or more of the blocks of the process 700 may be performed in parallel.

FIG. 8 is a diagram illustrating an example process 800 performed, for example, by a network entity. The process 800 is an example where the network entity (for example, base station 110) performs operations associated with switching configurations for uplink transmission switching.

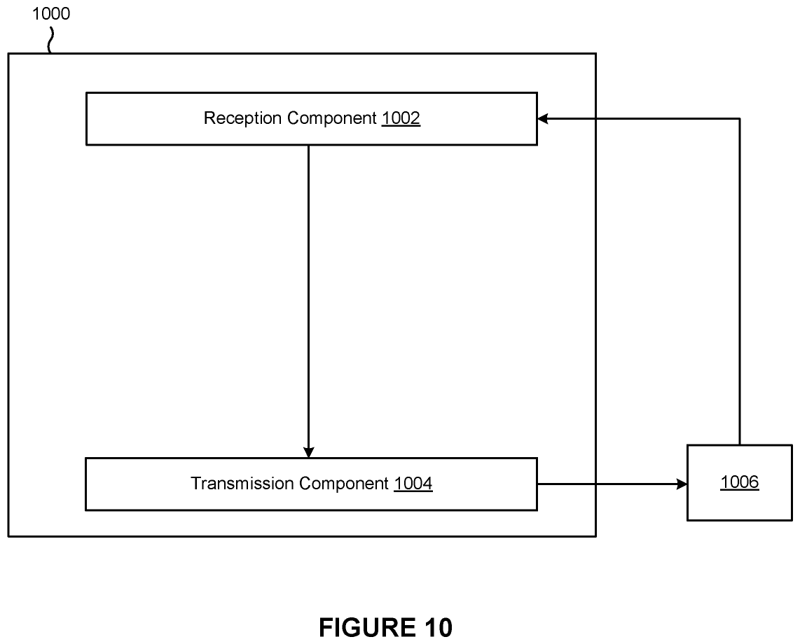

As shown in FIG. 8, in some aspects, the process 800 may include transmitting, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period (block 810). For example, the network entity (such as by using transmission component 1004, depicted in FIG. 10) may transmit, to a UE, a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period.

As further shown in FIG. 8, in some aspects, the process 800 may include receiving, from the UE, an uplink transmission associated with the switching configuration for the uplink transmission switching (block 820). For example, the network entity (such as by using reception component 1002, depicted in FIG. 10) may receive, from the UE, an uplink transmission associated with the switching configuration for the uplink transmission switching.

The process 800 may include additional aspects, such as any single aspect or any combination of aspects described in connection with the process 800 or in connection with one or more other processes described elsewhere herein.

In a first additional aspect, the process 800 includes the switching configuration permits switching from one carrier within the time period, or the switching configuration permits switching to one carrier within the time period.

In a second additional aspect, alone or in combination with the first aspect, the time period is one slot or a quantity of consecutive symbols.

In a third additional aspect, alone or in combination with one or more of the first and second aspects, the process 800 includes receiving, from the UE, capability signaling indicating that the UE is capable of switching from two carriers within the time period, or that the UE is capable of switching to the two carriers within the time period.

In a fourth additional aspect, alone or in combination with one or more of the first through third aspects, the switching configuration permits switching from two carriers within the time period associated with the capability signaling, or the switching configuration permits switching to two carriers within the time period associated with the capability signaling.

In a fifth additional aspect, alone or in combination with one or more of the first through fourth aspects, one carrier of the three or more carriers is associated with one uplink transmission chain prior to the uplink transmission switching and after the uplink transmission switching.

Although FIG. 8 shows example blocks of the process 800, in some aspects, the process 800 may include additional blocks, fewer blocks, different blocks, or differently arranged blocks than those depicted in FIG. 8. Additionally, or alternatively, two or more of the blocks of the process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a switching component 908, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network entity, a switching configuration for an uplink transmission switching for three or more carriers, where the switching configuration is associated with switching one or more uplink transmission chains of the UE from one or more carriers of the three or more carriers within a time period, or switching the one or more uplink transmission chains of the UE to the one or more carriers of the three or more carriers within the time period. The switching component 908 may switch the one or more uplink transmission chains of the UE associated with the switching configuration for the uplink transmission switching. The transmission component 904 may transmit, to the network entity, capability signaling indicating that the UE is capable of switching from two carriers within the time period, or that the UE is capable of switching to the two carriers within the time period.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The transmission component 1004 may transmit, to a UE, a switching configuration for an uplink transmission switching at the UE for three or more carriers, where the switching configuration is associated with switching one or more uplink transmission chains of the UE from one or more carriers of the three or more carriers within a time period, or switching the one or more uplink transmission chains of the UE to the one or more carriers of the three or more carriers within the time period. The reception component 1002 may receive, from the UE, an uplink transmission associated with the switching configuration for the uplink transmission switching. The reception component 1002 may receive, from the UE, capability signaling indicating that the UE is capable of switching from two carriers within the time period, or that the UE is capable of switching to the two carriers within the time period.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), including: receiving, from a network entity, a switching configuration for an uplink transmission switching for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period; and switching the one or more uplink transmission chains of the UE associated with the switching configuration for the uplink transmission switching.

Aspect 2: The method of Aspect 1, where the switching configuration permits switching from one carrier within the time period.

Aspect 3: The method of any of Aspects 1 through 2, where the switching configuration permits switching to one carrier within the time period.

Aspect 4: The method of any of Aspects 1 through 3, where the time period is one slot or a quantity of consecutive symbols.

Aspect 5: The method of any of Aspects 1 through 4, where the three or more carriers include three carriers associated with three bands, respectively, or the three or more carriers include three non-contiguous carriers associated with less than three bands.

Aspect 6: The method of any of Aspects 1 through 5, further including: transmitting, to the network entity, capability signaling indicating that the UE is capable of switching from two carriers within the time period, or that the UE is capable of switching to the two carriers within the time period.

Aspect 7: The method of Aspect 6, where the switching configuration permits switching from two carriers within the time period associated with the capability signaling.

Aspect 8: The method of Aspect 6, where the switching configuration permits switching to two carriers within the time period associated with the capability signaling.

Aspect 9: The method of any of Aspects 1 through 8, where one carrier of the three or more carriers is associated with one uplink transmission chain prior to the uplink transmission switching and after the uplink transmission switching.

Aspect 10: A method of wireless communication performed by a network entity, including: transmitting, to a user equipment (UE), a switching configuration for an uplink transmission switching at the UE for three or more carriers, where the switching configuration is associated with: switching one or more uplink transmission chains of the UE from one or more carriers of the three or more carriers within a time period, or switching the one or more uplink transmission chains of the UE to the one or more carriers of the three or more carriers within the time period; and receiving, from the UE, an uplink transmission associated with the switching configuration for the uplink transmission switching.

Aspect 11: The method of Aspect 10, where: the switching configuration permits switching from one carrier within the time period; or the switching configuration permits switching to one carrier within the time period.

Aspect 12: The method of any of Aspects 10 through 11, where the time period is one slot or a quantity of consecutive symbols.

Aspect 13: The method of any of Aspects 10 through 12, further including: receiving, from the UE, capability signaling indicating that the UE is capable of switching from two carriers within the time period, or that the UE is capable of switching to the two carriers within the time period.

Aspect 14: The method of Aspect 13, where: the switching configuration permits switching from two carriers within the time period associated with the capability signaling; or the switching configuration permits switching to two carriers within the time period associated with the capability signaling.

Aspect 15: The method of any of Aspects 10 through 14, where one carrier of the three or more carriers is associated with one uplink transmission chain prior to the uplink transmission switching and after the uplink transmission switching.

Aspect 16: An apparatus for wireless communication at a device, including a processor; memory coupled with the processor; and instructions stored in the memory and executable by the processor to cause the apparatus to perform the method of one or more of Aspects 1-11.

Aspect 17: A device for wireless communication, including a memory and one or more processors coupled to the memory, the one or more processors configured to perform the method of one or more of Aspects 1-11.

Aspect 18: An apparatus for wireless communication, including at least one means for performing the method of one or more of Aspects 1-11.

Aspect 19: A non-transitory computer-readable medium storing code for wireless communication, the code including instructions executable by a processor to perform the method of one or more of Aspects 1-11.

Aspect 20: A non-transitory computer-readable medium storing a set of instructions for wireless communication, the set of instructions including one or more instructions that, when executed by one or more processors of a device, cause the device to perform the method of one or more of Aspects 1-11.

Aspect 21: An apparatus for wireless communication at a device, including a processor; memory coupled with the processor; and instructions stored in the memory and executable by the processor to cause the apparatus to perform the method of one or more of Aspects 10-15.

Aspect 22: A device for wireless communication, including a memory and one or more processors coupled to the memory, the one or more processors configured to perform the method of one or more of Aspects 10-15.

Aspect 23: An apparatus for wireless communication, including at least one means for performing the method of one or more of Aspects 10-15.

Aspect 24: A non-transitory computer-readable medium storing code for wireless communication, the code including instructions executable by a processor to perform the method of one or more of Aspects 10-15.

Aspect 25: A non-transitory computer-readable medium storing a set of instructions for wireless communication, the set of instructions including one or more instructions that, when executed by one or more processors of a device, cause the device to perform the method of one or more of Aspects 10-15.

The foregoing disclosure provides illustration and description but is not intended to be exhaustive or to limit the aspects to the precise forms disclosed. Modifications and variations may be made in light of the disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving, from a network entity, a switching configuration for an uplink transmission switching for three or more carriers, wherein the switching configuration is associated with:
switching one or more uplink transmission chains of the UE from one or more carriers of the three or more carriers within a time period, or
switching the one or more uplink transmission chains of the UE to the one or more carriers of the three or more carriers within the time period; and
switching the one or more uplink transmission chains of the UE associated with the switching configuration for the uplink transmission switching.

2. The method of claim 1, wherein the switching configuration permits switching from one carrier within the time period.

3. The method of claim 1, wherein the switching configuration permits switching to one carrier within the time period.

4. The method of claim 1, wherein the time period is one slot or a quantity of consecutive symbols.

5. The method of claim 1, wherein the three or more carriers include three carriers associated with three bands, respectively, or the three or more carriers include three non-contiguous carriers associated with less than three bands.

6. The method of claim 1, further comprising:
transmitting, to the network entity, capability signaling indicating that the UE is capable of switching from two carriers within the time period, or that the UE is capable of switching to the two carriers within the time period.

7. The method of claim 6, wherein the switching configuration permits switching from two carriers within the time period associated with the capability signaling.

8. The method of claim 6, wherein the switching configuration permits switching to two carriers within the time period associated with the capability signaling.

9. The method of claim 1, wherein one carrier of the three or more carriers is associated with one uplink transmission chain prior to the uplink transmission switching and after the uplink transmission switching.

10. A method of wireless communication performed by a network entity, comprising:
transmitting, to a user equipment (UE), a switching configuration for an uplink transmission switching at the UE for three or more carriers, wherein the switching configuration is associated with:
switching one or more uplink transmission chains of the UE from one or more carriers of the three or more carriers within a time period, or
switching the one or more uplink transmission chains of the UE to the one or more carriers of the three or more carriers within the time period; and
receiving, from the UE, an uplink transmission associated with the switching configuration for the uplink transmission switching.

11. The method of claim 10, wherein:
the switching configuration permits switching from one carrier within the time period; or
the switching configuration permits switching to one carrier within the time period.

12. The method of claim 10, wherein the time period is one slot or a quantity of consecutive symbols.

13. The method of claim 10, further comprising:
receiving, from the UE, capability signaling indicating that the UE is capable of switching from two carriers within the time period, or that the UE is capable of switching to the two carriers within the time period.

14. The method of claim 13, wherein:
the switching configuration permits switching from two carriers within the time period associated with the capability signaling; or
the switching configuration permits switching to two carriers within the time period associated with the capability signaling.

15. The method of claim 10, wherein one carrier of the three or more carriers is associated with one uplink transmission chain prior to the uplink transmission switching and after the uplink transmission switching.

16. An apparatus for wireless communication at a user equipment (UE), comprising:
a first interface configured to receive, from a network entity, a switching configuration for an uplink transmission switching at the UE for three or more carriers, wherein the switching configuration is associated with:
switching one or more uplink transmission chains of the UE from one or more carriers of the three or more carriers within a time period, or
switching the one or more uplink transmission chains of the UE to the one or more carriers of the three or more carriers within the time period; and
a processing system configured to switch the one or more uplink transmission chains of the UE associated with the switching configuration for the uplink transmission switching.

17. The apparatus of claim 16, wherein the switching configuration permits switching from one carrier within the time period.

18. The apparatus of claim 16, wherein the switching configuration permits switching to one carrier within the time period.

19. The apparatus of claim 16, wherein the time period is one slot or a quantity of consecutive symbols.

20. The apparatus of claim 16, wherein the three or more carriers include three carriers associated with three bands, respectively, or the three or more carriers include three non-contiguous carriers associated with less than three bands.

21. The apparatus of claim 16, wherein the first interface or a second interface is configured to:
output, to the network entity, capability signaling indicating that the UE is capable of switching from two carriers within the time period, or that the UE is capable of switching to the two carriers within the time period.

22. The apparatus of claim 21, wherein the switching configuration permits switching from two carriers within the time period associated with the capability signaling.

23. The apparatus of claim 21, wherein the switching configuration permits switching to two carriers within the time period associated with the capability signaling.

24. The apparatus of claim 16, wherein one carrier of the three or more carriers is associated with one uplink transmission chain prior to the uplink transmission switching and after the uplink transmission switching.

25. An apparatus for wireless communication at a network entity, comprising:
a first interface configured to output, to a user equipment (UE), a switching configuration for an uplink transmission switching at the UE for three or more carriers, wherein the switching configuration is associated with:
switching one or more uplink transmission chains of the UE from one or more carriers of the three or more carriers within a time period, or
switching the one or more uplink transmission chains of the UE to the one or more carriers of the three or more carriers within the time period; and
the first interface or a second interface configured to obtain, from the UE, an uplink transmission associated with the switching configuration for the uplink transmission switching.

26. The apparatus of claim 25, wherein:
the switching configuration permits switching from one carrier within the time period; or
the switching configuration permits switching to one carrier within the time period.

27. The apparatus of claim 25, wherein the time period is one slot or a quantity of consecutive symbols.

28. The apparatus of claim 25, wherein the first interface or the second interface is further configured to:
obtain, from the UE, capability signaling indicating that the UE is capable of switching from two carriers within the time period, or that the UE is capable of switching to the two carriers within the time period.

29. The apparatus of claim 28, wherein:
the switching configuration permits switching from two carriers within the time period associated with the capability signaling; or
the switching configuration permits switching to two carriers within the time period associated with the capability signaling.

30. The apparatus of claim 25, wherein one carrier of the three or more carriers is associated with one uplink transmission chain prior to the uplink transmission switching and after the uplink transmission switching.
